(19) United States
(12) Patent Application Publication
(10) Pub. No.: US 2022/0359096 A1
(43) Pub. Date: Nov. 10, 2022

(54) ELECTROCHEMICAL SURFACE TREATMENT

(71) Applicant: C-Tech Innovation Limited, Chester (GB)

(72) Inventors: John COLLINS, Chester (GB); Robert BELL, Chester (GB)

(21) Appl. No.: 17/622,625

(22) PCT Filed: Jun. 25, 2020
(86) PCT No.: PCT/GB2020/051547

§ 371 Date: Dec. 23, 2021

(30) Foreign Application Priority Data
Jun. 25, 2019 (GB) 1909090.1

(51) Int. Cl. G21F 9/00; C25F 1/06; C25F 7/00; G21F 9/30

(52) U.S. Cl. CPC G21F 9/004; C25F 1/06; C25F 7/00; G21F 9/30

(57) ABSTRACT

A method and apparatus for the electrochemical removal of material from a surface in which two or more fluid jets or flows are arranged to impinge on the surface of the object and an electrical current flows through one fluid flow path, through the object, and then through a second fluid flow path.

### BACKGROUND OF INVENTION

### 1. Field of the Invention

This invention relates to electrochemical surface treatment. Its primary application is to surfaces contaminated by radionuclides.

### 2. The Prior Art

Decontamination of metal surfaces is a common problem in industry, including in the nuclear industry where metal comes into contact with radionuclides and becomes contaminated. Contaminated metal may include ducting, pipework, glove boxes, storage vessels, mechanical parts such as stirrers etc. Once the metal has been in contact with media containing radioactive species then there remains behind on the surface some residual radioactivity which cannot be removed by simple rinsing or washing, since the radioactive elements have either reacted with the surface or else penetrated a short way into it. There may be some diffusion into the surface, either directly into the surface of the metal and or along cracks propagating into the metal. The result is that there is radioactivity associated with the surface.

It is therefore desirable to remove radioactive contamination from the surfaces of objects. If the classification of such materials can be lowered, then there is a considerable practical advantage in the decommissioning of nuclear plant since a greater part of the contaminated material can be handled with less risk to operators and with less requirement for high-level radioactive waste storage.

Handling of contaminated material is often a challenge as operators cannot get close to it or are unable to be near it for long periods, since proximity contributes to the allowable radiation exposure to operators. Additional precautions and methods and facilities are required therefore to deal with this contamination, with the objectives of removing the contamination, minimising hazard to health, and recovering decontaminated metal for re-use via conventional recycling processes.

An additional challenge is that surface contamination is not static—it can change in response to a surface treatment. It is found in some instances that after removal of a contaminated surface layer that the contamination “sweats back”—that is to say that the radioactivity at the surface is reduced after the decontamination treatment but then subsequently increases. This results from diffusion of species from the sub-surface layer to the newly created surface. This underlines the need for having effective control over any decontamination process.

A conventional means to deal with this problem is the physical removal and disposal of the whole object. The obvious drawback to this method is that the quantity of contaminated material to be disposed of or stored is larger, and there is no possibility to return any of the material to general use via recycling.

A second means is to use a smelter as described in U.S. Pat. No. 5,268,128 (WESTINGHOUSE) Jul. 12, 1993 “Method and apparatus for cleaning contaminated particulate material”, with operating conditions such that the radioactive contamination ends up in the slag, which can be isolated and then stored indefinitely, combined with treatment of the radioactive metal waste using melt decontamination as described in US 2013296629 A (KEPCO NUCLEAR FUEL CO LIMITED) Jul. 11, 2013 and recovering the bulk of the metal as an uncontaminated stream for reuse. This process is operated commercially. The disadvantage of this approach is that a large facility is required, which itself requires extensive control measures.

It is preferable therefore to have a means of decontaminating the material such that the larger part of the metallic object can be recycled without further precaution. This may be applied in-situ, to vessels for example, so that dismantling and decommissioning operations can be carried out with reduced hazard, and it may be applied after dismantling and with the objective of recovering more material for re-use.

One method is to chemically dissolve the contaminated layer of metal, including any oxide or other deposited layer. The challenge is to dissolve this contaminated layer completely whilst at the same time dissolving only a finite and controlled amount of the uncontaminated substrate metal. Acid treatments are used for mild steel and stainless steel including 304 stainless steel and for other materials. Nitric acid is commonly used in the nuclear industry because of the high solubility of the contaminants of interest as nitrates, and because of the good corrosion resistance of 304 stainless steel to nitric acid. The radioactive contamination is recovered from the nitric acid by standard means including precipitation and flocculation, for example as used in the Enhanced Actinide Removal Plant (EARP) at Sellafield, UK.

Other chemical treatments of metal surfaces are known in the metals finishing industries where thermal processing of metals gives rise to an oxide surface layer which must be removed before further processing steps can be carried out. Various chemical treatments are known including the use of acetic acid (hence the use of the term “pickling”), sulphuric acid and other or additional agents such as hydrochloric acid for mild steel and hydrofluoric acid for stainless steel, or hydrofluoric/nitric acid mixtures. These treatments are not preferred for use in nuclear decontamination because they are incompatible with the stainless-steel construction of the downstream effluent treatment plants.

A limitation with the use of nitric acid as a dissolution agent is that the dissolution reaction is slow so that relatively larger plants are required to deal with the large volumes of acid reagents required. The rate of reaction can be increased through the addition of complexing agents such as chloride, fluoride, and organic complexing agents such as citric acid, oxalic acid, and ethylene diamine tetra acetic acid. These agents increase the rate of reaction with the surface contamination but at the expense of creating a liquid which is more corrosive, and which cannot be treated using conventional nuclear effluent treatment plant, being corrosive to the metals used in their construction.

A different method of surface decontamination is described in U.S. Pat. No. 7,384,529 B (US ENERGY) Oct. 6, 2008 “Method for electrochemical decontamination of radioactive metal”, where a current is passed through the contaminated article using a conductive electrolyte bath. Electrochemical descaling (or “electro-pickling”) is commonly used in metals processing. This method has the significant advantage over chemical methods in that the rate of surface removal is very much greater than with chemical methods. The practical consequence is that an electrochemical treatment requires a much smaller quantity of acid reagent that a chemical treatment. An additional advantage is that electrochemical processes are easily controllable since an electrochemical process responds immediately to the level of current passing which in turn is determined by the electrical potential applied. Electrochemical processes have the significant drawback however in that they are only effective where the geometry allows the placement of the counter-electrode close to the working piece. This is because in a flooded system the electric current is able to pass through the electrolyte to the whole surface in contact with the fluid and the electrochemical effect will either spread out quickly away from the counter electrode on an even surface, or will be concentrated on a point offering the lowest resistance path.

It has been shown in US 2003075456 A (COLLINS ET AL) 24 Apr. 2003 that it is possible to descale a wide range of metals coated with oxide films more rapidly using AC waveforms with DC bias, than when using AC waveforms without DC bias. It was also shown that it can be advantageous to periodically reverse the polarity of the DC bias. Removal or cleaning of the oxide layers on the surface of metals was shown to be faster when a DC bias was applied to an AC waveform, compared to the use of AC current alone. The cleaning mechanism involves some dissolution of the contaminated layer, some undercutting where the underlying metal is dissolved, and some scrubbing action resulting from the generation of gas bubbles at the interface.

AC with DC bias allows breakdown of oxide film faster—because in the potential range where dissolution occurs DC current alone leads to either passivation of the surface or oxygen evolution and pitting, whereas AC current alone gives a reduced dissolution effect. AC current with DC bias is found to give the optimum dissolution whilst minimizing localized pitting.

Electrochemistry has previously been used with non-metals and the work of Bradley et al (U.S. Pat. No. 3,075,902) shows that the use of static jets in contact with a surface can be used for localized measurement of the thickness and thinning of semiconductors. In this disclosure we are taught that the measurement of thickness of the material remaining is an essential feature in the processes used to etch a specific thickness of material. The measurement process is achieved by monitoring the electrical resistance between two electrodes through the thickness of the semiconductor wafer. This method of measurement is not suitable for conductive metals where it is not possible to determine thickness through the change in the resistance as the resistance of the electrolytes is an order of magnitude greater than the metallic conductor.

The electrochemical treatment of surfaces using a jet or stream of electrolyte that impinges on an object and carries the electrical current to the object is known. This method finds application for electroplating, electroforming, electrochemical etching, electrochemical machining, cutting, and electropolishing.

When used for electrochemical machining the use of an impinging jet of electrolyte allows for the machining of shapes that would otherwise be difficult to manufacture using other methods. Various configurations of equipment are known with different constructions of nozzle, different means of introducing the electric current to the flowing liquid stream, different mechanical arrangements for the support and movement of the head relative to the object or vice versa, different means of collecting and recirculating and filtering the electrolyte, different electrical polarizations and waveforms. Common to these applications is the use of a single flow of electrolyte to the object and an electrical current path that flows from electrical supply through the electrolyte to the object and returns from the object to the supply through a wiring system.

The use of an impinging jet for the purpose of electrochemical surface decontamination is advantageous because it obviates the need for the treated surface to be flooded with electrolyte, it allows a greater degree of spatial control of the area being treated, and it provides an effective means of rapidly removing heat from the electrolyte and gas from the object. When treating the interior surfaces of large vessels this means that the vessel does not need to be flooded and smaller volumes of electrolyte can be used. This use of an impinging jet is a development of the electrochemical decontamination of a surface whereby the object and counter electrode are immersed in a bath of electrolyte and a current is passed between the two.

Systems using an impinging jet for the purpose of etching a metallic surface find application in various sectors including for the purpose of the removal of radioactive contamination from the surface layers of nuclear plant. In such systems, the object is the surface to be decontaminated and constitutes one electrode and the second electrode is in contact with the stream of electrolyte, either in part of the structure of the nozzle or piping or else in the stream of electrolyte before it leaves the nozzle.

A disadvantage of the method is that the surface being treated forms a part of the electrical circuit and a good electrical connection needs to be made to the object to close the circuit. If the connection is poor, then the effectiveness of the process is compromised. When the electrolyte jet is being scanned or moved along parts of contaminated vessels or pipework including in situations where access to the area is difficult and must be by means of a remotely operated device then it is advantageous not to have to make this electrical connection.

### SUMMARY OF THE INVENTION

According to the present invention of electrochemical removal of material from a surface of a conducting metallic object is characterized in that two or more fluid jets or laminar flows are arranged to impinge on the surface and an electrical current flows to the metallic object through one fluid flow path in at least one jet or flow, through the object material, and away from the metallic object through a second fluid flow path in at least one second jet or laminar flow.

This arrangement has an advantage over previous systems in that no direct electrical connection needs to be made to the object. The liquid jet device may be brought into proximity of the object and treatment carried out without needing to make any electrical connection.

In this new arrangement electrochemical removal of materials takes place at one or more points of impingement of one or more jets via anodic processes and cathodic processes take place at the points of impingement of one or more additional electrolyte jets. The polarization of the electrical supply to the object may preferentially be periodically alternated so that the electrochemical effects happening at the impingement points of the two or more jets are alternated between anodic and cathodic. The waveform of the applied current and voltage may be advantageously adjusted to optimize the electrochemical effect such as by using DC biased AC waveforms or any other suitable waveform. Different frequencies of alternating current may be used.

The current density to be used at the surface of the object will depend on a variety of factors and may be in the range 0.1 amps per square centimeter to over 100 amps per square centimeter. Intermediate current densities may be preferred that offer a suitable balance between the maximizing the rate of treatment and minimizing the generation of heat in the electrolyte and gas at the surface of the object.

Two or more jets may be used. When the number of flow paths is greater than two then one or more flow paths will be designated for current flow in one direction and the remaining flow paths designated as flow paths for current flowing in the opposite direction.

The transformer is isolating which is to say that no part of the secondary circuit is grounded, as is existing common practice. The arrangement obviates the need for any electrical connection to be made to the object other than through the liquid jets and also means that there is no possible current path from the object other than through the fluid jets and therefore that there is no possibility of unwanted electrochemical effects taking place at remote locations away from the intended working area.

The current density to be used at the surface of the object will depend on a variety of factors and may be in the range 0.1 amps per square centimeter to over 100 amps per square centimeter. Intermediate current densities may be preferred that offer a suitable balance between the maximizing the rate of treatment and minimizing the generation of heat in the electrolyte and gas at the surface of the object.

In another aspect of the invention apparatus for the electrochemical removal of material containing radionuclides from the surface of a conducting metallic object comprises two or more coherent fluid jets or laminar flows of electrolyte arranged to impinge on the surface of metallic electrically conductive object providing an electrical current path through at least one of the fluid jets or laminar flows, the object, and through a least one other of the fluid jet or flow paths, and having flexible and electrically insulating material conduits to supply the electrolyte flows to outlets close to the surface and electrodes in the conduits or outlets to introduce current to the electrolyte.

### BRIEF DESCRIPTION OF THE DRAWINGS

FIG. 1 illustrates schematically one illustrative embodiment of the invention configured for the surface treatment of the interior of a vessel;

FIG. 2 is a schematic cross section of internal surface of a vessel being decontaminated internally by a methods and apparatus according to the invention; and

FIG. 3 illustrates an exploded view of one outlet and connecting ducts to project a jet of electrolyte towards a contaminated surface.

### DETAILED DESCRIPTION OF THE PREFERRED EMBODIMENTS

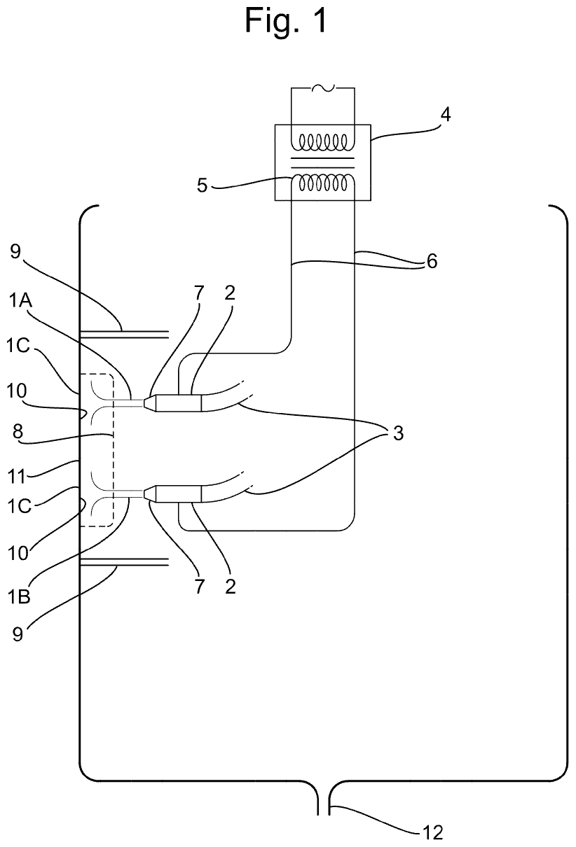

In FIG. 1 two coherent fluid jets or laminar flows 1A and 1B of electrolyte (more than two may be provided but the additional jets are omitted for simplicity) are arranged to impinge at different points 1C on a radionuclide contaminated surface 10 of an object 11 comprising an electrically conducting material. The jets emanate from outlets 7 from ducts 2 which are connected through pipes 3 to a source of electrolyte, the electrolyte being pumped through the pipes at a sufficient pressure to maintain a suitable fluid flow. In the figure, outlets 7 comprise nozzles but they may be orifice plates or slots. In one implementation the outlet was an orifice plate with a circular shape with a radius of between 5 mm and 100 mm. In another implementation, coherent fluid jets were formed by an annular slot or partial annular slot in each outlet 7.

An isolating transformer 4 is arranged to supply electrical power with a current path from the secondary winding 5 of the transformer through one jet 1A fluid flow path, through the object 11, returning through a second the second jet 1B and back to the secondary winding 5.

No part of the secondary circuit through winding 5 is grounded resulting in the transformer 4 being isolating. This contrasts with common existing practice, where one side of the transformer winding 5 would be connected to the object 11. In contrast, in this invention, only electrical connection to the object 11 is through the jets 1A and 1B through surface 10. As a result, with no possible current path from the object 11 other than through the jets 1A and 1B, there is no possibility of unwanted electrochemical effects taking place at remote locations away from the intended working area.

The use of impinging jet 1A and 1B for the purpose of electrochemically material removal from a metallic surface finds application in various sectors including for the purpose of the removal of radioactive contamination from the surface layers of nuclear plant.

Sponges 8 or other porous media may be used to control the flow of the fluid streams in the vicinity of the impingement points and reduce unwanted splashing and distribution of the liquid away from working area of the surface 10 and to localize the flow in the vicinity of the working area.

Flexible seals 9 may be placed partially or completely around working area of the surface 10 to contain splashes, at least partly, and to help direct and collect the electrolyte after it impinges the surface 10.

Shaped openings such as annular partial annular slots may also be used to localize flows around features.

Electrolyte that has impinged on the surface 10 of object 11 will flow to a suitable collection point 12 either at the lowest point of an internal vessel or else along a pipe.

The electric current may be introduced into the jets 1A and 1B by various means including by conducting nozzles 7 or by electrodes within the ducts 2 or by electrodes in the electrolyte jet once it has left the nozzle, in any case with said electrode connected by wires 6 to each side of the secondary coil 5. The material that imparts the electric current to the electrolyte flow, whether part of the nozzle or pipe structure or external to the nozzle or pipe structure, is preferably of a material that will not be consumed by an electrochemical process.

The ducts 2 and piping 3 that carry electrolyte to the outlets 7 is of an insulating material such as plastic and the piping 3 is of sufficient length that the electrical resistance of the flow path from one liquid stream to another along the pipework is considerably greater than the electrical resistance through the jet flow paths and through the work piece.

The ducts 2 and outlets 7 may be of a flexible electrically insulating material such as rubber so that contact of the ducts and nozzles with the object does not cause a problem. In this instance the electrodes that impart current to the electrolyte flow must be within the ducting 2.

In the embodiment described the material removal from the metallic surface is typically between 0.001 millimeter and 10 millimeters inclusive. This can be done in a single pass or in more than one pass.

Typically, the time averaged rate of movement of the impact point of the jets on the surface is between 0.01 and 10 times inclusive the diameter of the fluid path per second.

The applied waveform was an DC biased AC waveform whose frequency was between 5 and 2000 Hz inclusive. The preferred current density in the fluid jet is between one hundred and one hundred thousand amps per square meter inclusive.

The transformer 4 is isolating which is to say that no part of the secondary circuit is grounded, as is existing common practice. The arrangement obviates the need for any electrical connection to be made to the object 11 other than through the liquid jets and also means that there is no possible current path from the object 11 other than through the fluid jets and therefore that there is no possibility of unwanted electrochemical effects taking place at remote locations away from the intended working area.

The distance between the points of impingement of the several jets or laminar flows on the surface 10 of the object 11 will be arranged so that the electrical resistance of the object 11 between those points is such that the surface treatment rate meets the operational requirement. Typically this means that the electrical resistance of the object 11 between the points of impingement of the electrolyte jets or flows is less than the electrical resistance of the electrolyte liquid present at the surface of the metal between those two points but this is not necessarily always the case. It may be for example that for the treatment of particularly inaccessible locations the electrical efficiency of the process is sacrificed in favor of geometrical convenience of access and it is accepted that additional power is lost due to conduction along the electrolyte on the surface 10 of the object.

The spatial orientation of the electrolyte flows 1A and 1B and points of impingement 1C may be optimized for the geometry of the object being treated. Arrays of jets or extended jets may be used. For the treatment of the exterior of pipes the jets may be arranged in an annular or part annular shape for example. For the treatment of the interior of a vessel jets may be arranged in radiating shapes emanating in multiple directions for example.

The movement of the points of impingement 1C of the jets or laminar flows 1A and 1B over the surface 10 of the object 11 may be programmed in advance to obtain a pre-determined profile of surface treatment. A program that controls the movement may have regard both for the level of contamination or depth of surface removal required and for the effects of geometry of application on the intensity of treatment. The automatically controlled movement of the electrolyte jets or laminar flows 1A and 1B may also be controlled by measurements of a property of the surface being treated that are made in a survey before the treatment is carried out or in real-time, such as the level of radioactivity present or its reflectivity of light or another suitable measurable property.

The movement of the multiple jets or laminar flows 1A and 1B over the surface being treated may be controlled in such a way that a predetermined level of surface treatment or removal is achieved. This level may have been determined by prior radiological assessment of the substrate in question.

High pressure electrolyte jets or laminar flows or jets may be advantageously used to provide a mechanical surface treatment effect in addition to the electrochemical effect described, constituting in effect a pressure-washing. This is useful when there is surface contamination such as oil or grease or particulate matter or paint or other substances that need to be removed. Solid particulate matter may optionally be dispersed in the liquid electrolyte to provide an additional abrasive cleaning effect.

The production of a continuous and coherent fluid path from the electrode contained in an electrode housing (in the illustrated embodiment the housing is the ducting 2) to the surface 10 of the object 11 is essential for the operation of the system. The fluid path resistance will vary significantly if the jet or flow is broken or forms droplets between outlet 7 and the surface 10 being treated. The generation of coherent flows is achieved using flow conditioning in the electrode housing (duct 2) and reduces the velocity variation from the conduit. This is preferably achieved by expansion of the cross section of duct 2 to reduce velocity of the flow, controlled pressure drops and flow straitening prior to the outlet 7 which is an orifice plate, nozzle or slot which generates a fluid jet with a low variation in velocity. The coherent jets preferably have a continuous path for over 1 meter in free space, but practical voltage limitations limit preferred operating distances to below 0.5 meters.

The electrodes are preferably a stable material with good electrical conductivity. Suitable are a carbon-based conductor or a metallic conductor or metallic conductor with an applied surface coating. Preferably the metal conductor or metal surface coating comprises a metal selected from the group comprising platinum, gold, stainless steel, chromium, nickel, tantalum, osmium, iridium, palladium.

The exposed surface area of the electrodes in contact with the fluid is ideally greater than or equal to 5% of the cross-section area of the fluid jet. The electrode is in contact with the electrolyte before the fluid leaves the outlet 7 and is preferably sized to reduce localized current density in the housing (duct 2). Practical arrangements for the electrodes include a perforated surface or mesh mounted in an electrically insulating housing (which in the illustrated embodiment is also the duct 2). An electrode forming the part of the edge of the flow path such as a ring in an electrically insulating housing. An electrode inserted into the flow path such as a tube or rod in an electrically insulating housing. An electrode orifice plate at or near the jet exit which also defines the flow. A combined electrode and flow conditioning arrangement made of a material which also acts as an electrode.

The electrically insulating housing can contain means of fluid flow conditioning such as multiple parallel tubes, or perforated plates. The parallel tubes and/or perforated plates in the electrically insulating housing can also form part or all of the electrode in that housing.

The electrode is in contact with the electrolyte before the fluid leaves the outlet 7 and is preferably sized to reduce localized current density in the housing (duct 2). The electrode may be shaped as a ring or cylinder or preferably as a mesh or perforated plate located in the electrode housing (duct 2) or the outlets 7 can also be the electrodes.

The method and apparatus described is applicable for threating a wide range of geometries of contaminated surface. This includes the interior and exterior of pipes, the interior and exterior of vessels, structures of various sorts including valves, pipe manifolds, support structures, discrete components or any surface that needs surface treatment. The method is suited for the treatment of localized hot spots of contamination.

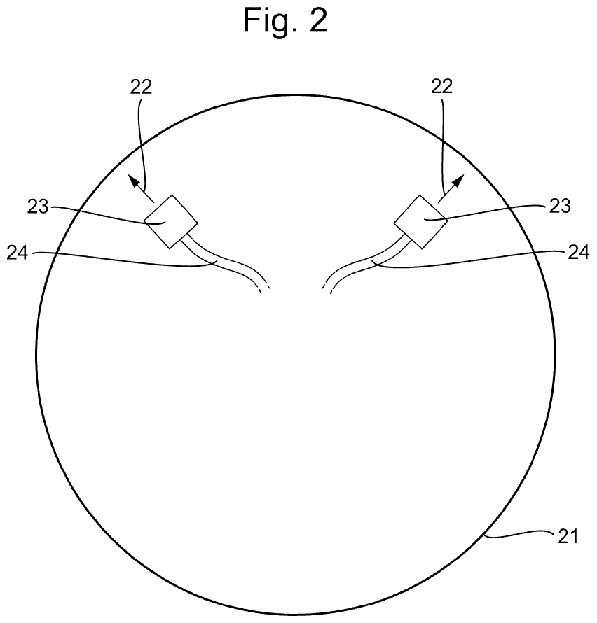

FIG. 2 illustrates the treatment of a cylindrical vessel 21 using two electrolyte jets 22 directed at the inside surface of the vessel 21. The two electrolyte jets, 22, are shown as arrows and have divergent paths. The nozzles are shown as 23 (in this embodiment these perform the function of the outlets 7 in FIG. 1), and the electrolyte supply to the nozzles as 24 (this performs the function of duct 2 in FIG. 1).

In order to treat the surface of a component that is larger than the cross section, the impact points 1C of the fluid jet on the surface are moved. The rate of movement is proportional to the size of the area of the jet impact, the current density applied and indirectly proportional to the depth of material to be removed. The movement could be continuous, step wise or in a raster pattern depending on the features of the surface and the control methodology employed.

Although two jets or laminar flows 1A and 1B, and 22 are shown in FIGS. 1 and 2 respectively, multiple jets or laminar flows can be used.

In FIG. 1 the jets or laminar flows 1A and 1B are shown as bring parallel but the inventors have found that divergent jets as shown in FIG. 2 speeds the surface when the jets are directed at concave surfaces such as the inside of cylindrical vessels and ducts. Likewise, convergent jets may speed cleaning of convex surfaces such as the outside of cylindrical vessels.

It has been found that the best fluid velocity of the fluid forming the coherent jet or laminar flow is between 0.15 m/s and 50 m/s.

The electrolyte should be a conductive fluid, increased electrical conductivity reduces the voltage required. The fluid electrical resistivity should be less than 1 Ωmeter and preferably less than 0.2 S2 meter.

It is preferred that dissolved metals should have some solubility in the electrolyte to minimize the fluid volumes required to treat a given area and to prevent precipitation of removed metals.

It is preferred that the electrolyte should not chemically dissolve or cause localized damage to the substrate to any great extent and that the corrosion should be minimal over the total electrochemical treatment time. For stainless steels and most nickel alloys, nitric acid is the preferred choice as the chemical corrosion rate is not high and the acid is suitably conductive.

For the treatment of radioactive contamination from the nuclear industry, it is advantageous to use nitric acid or nitrate salts as many radionucleotides are soluble and it is often compatible with known waste treatment routes.

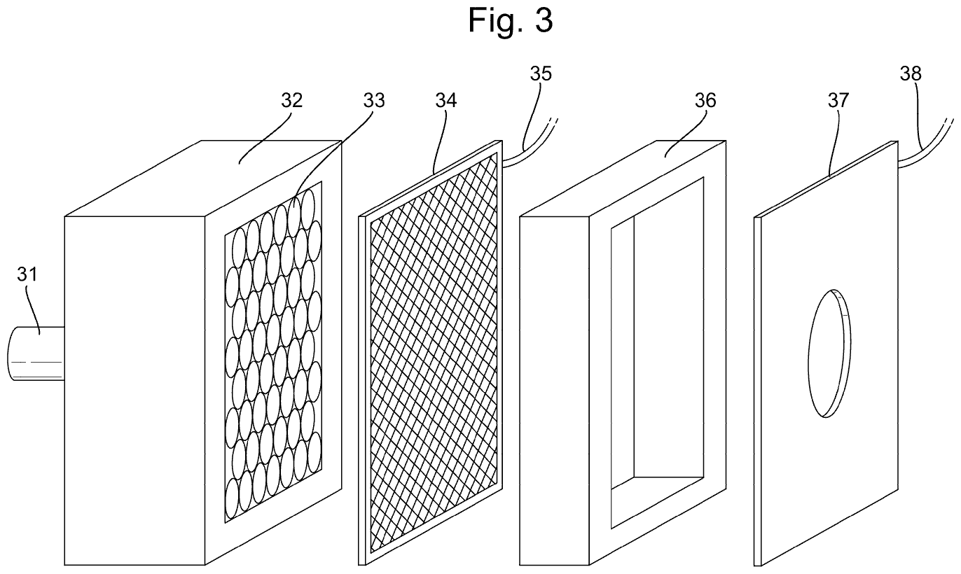

FIG. 3 illustrates one arrangement for the outlet 7 (in FIG. 1).

In FIG. 3, fluid enters through a conduit 31 (for example the piping 3 of FIG. 1) into an electrically insulated housing 32 (for example, the duct 2 of FIG. 1). Towards the exit face of the electrically insulated housing is an array of flow conditioning tubes 33. The electrolyte fluid then passes through a perforated plate electrode 34. This is connected to the electrical supply through electrical connection 35. Fluid then passes through a second electrically insulated housing 36, before leaving the outlet 7 through a hole in an orifice plate 37. The orifice plate also has an optional connection 38 to an electrical supply.

Examples of use of the use of the Illustrated Embodiment

### Example 1

A sample of 304 stainless steel sheet was treated using two jets which were located 90 mm apart and 50 mm away from the sheet sample surface. Nitric acid (30% w/w) was pumped through each 25 mm diameter nozzle to form the jets at a rate of 32001/hour. When electrodes in each nozzle were energized at 160V by an isolated power supply, a current of 25 A flowed through the circuit made of the two jets with current passing through the stainless steel object, without any direct contact to the sample from the isolated power supply and without any current passing to ground if the stainless steel sample was earthed. The sample was treated for 15 minutes and in that time lost 3.2 g of mass from the two jet/sample contact areas. This corresponds to a current efficiency for metal dissolution of 50%.

### Example 2

A sample of 304 stainless steel sheet was treated using two jets which were located 50 mm away from the sheet sample surface. Nitric acid (30% w/w) was pumped through each 25 mm diameter nozzle to form the jets at a rate of 32001/hour. When electrodes in each nozzle were energized at 160V by an isolated power supply, a current of 25 A flowed through the circuit made of the two jets with current passing through the stainless steel object, without any direct contact to the sample from the isolated power supply and without any current passing to ground if the stainless steel sample was earthed. One of the jets was traversed horizontally across the surface at a fixed rate removing 20 microns of material from the surface, along the path which the jet transited across the surface.

1-33. (canceled)

34. An apparatus for the electrochemical removal of material from a surface of a conducting metallic object characterized in that two or more fluid jets or laminar flows are arranged to impinge on the surface and an electrical current flows to the metallic object through one fluid flow path in at least one jet or flow, through the object material, and away from the metallic object through a second fluid flow path in at least one second jet or laminar flow.

35. The apparatus according to claim 34, in which two or more coherent fluid jets or laminar flows are arranged to impinge on a common surface of a metallic electrically conductive object material.

36. The apparatus according to claim 34, in which the material contains radionuclides.

37. The apparatus according to claim 34, in which the depth of material removal from the surface is between 0.001 millimeter and 10 millimeters inclusive.

38. The apparatus according to claim 34, wherein the treatment of a surface larger than the cross-sectional area of the fluid path is achieved by moving the contact point of one or more of the jets across the surface.

39. The apparatus according to claim 38, wherein an average rate of movement of an impact point on the surface is between 0.01 and 10 times, inclusive, a diameter of the fluid path per second.

40. The apparatus according to claim 34, where the applied electric current is in the form of DC biased AC waveform.

41. The apparatus according to claim 40, in which the current density in the fluid jet is between one hundred and one hundred thousand amps per square meter

42. The apparatus according to claim 34, wherein the trajectories of the coherent fluid jets fluid flow paths are divergent.

43. The apparatus according to claim 34, where the electrochemical material removal takes place in a series of sequential treatments.

44. The apparatus according to claim 34, wherein the fluid is contained in a volume adjacent to the object by means of a movable seal.

45. The apparatus according to claim 34, wherein the electrical current is passed from the secondary of an isolating transformer and the electrical current flows through one fluid flow path in at least one jet, through the object material, and to return through a second fluid flow path in at least one second jet and returns to a secondary transformer.

46. The apparatus according to claim 34, wherein a fluid in the jets or laminar flows is contained adjacent to the surface after impinging the surface by means of a porous material.

47. The apparatus according to claim 34, wherein the velocity of the fluid forming the coherent jet is between 0.15 m/s and 50 m/s.

48. The apparatus according to claim 34, characterized in that the electrical resistivity of the electrolyte is less than 1 Ωmeter.

49. The apparatus according to claim 34, further including flexible and electrically insulating material conduits to supply the electrolyte flows to outlets close to the surface and electrodes in the conduits or outlets to introduce current to the electrolyte.

50. The apparatus according to claim 49, in which the exposed surface area of the electrodes in contact with the fluid is greater than or equal to 5% of the cross-section area of the fluid jet.

51. The apparatus according to claim 49, in which at least one electrode is constructed of a perforated surface or mesh.

52. The apparatus according to claim 51, in which the electrodes are supported in an electrically insulating housing and the insulating housing contains means of fluid flow conditioning, multiple parallel tubes, or perforated plates, which form part or all the electrode.

53. The apparatus according to claim 34, in which one or more of the coherent fluid jets is formed by an orifice plate.
